(19) United States
(12) Patent Application Publication
(10) Pub. No.: US 2009/0257098 A1
(43) Pub. Date: Oct. 15, 2009

(54) Simplified Operation Of Scan And Print Devices

(76) Inventors: Sriganesh MADHVANATH, Bangalore (IN); Kenneth Kay Smith, Boise, ID (US); Anjaneyulu Seetha Rama Kuchibhotla, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/409,510

(22) Filed: Mar. 24, 2009

(30) Foreign Application Priority Data
Apr. 9, 2008 (IN) 890/CHE/2008

(51) Int. Cl. H04N 1/04

(52) U.S. Cl. 358/474; 715/230

(57) ABSTRACT

An apparatus comprising a document scanner and printer is controlled to scan a document and generate and print an annotation version of the document. A user-completed annotation version of the document is scanned and analyzed to detect one or more defined markings on the scanned document in addition to the document content desired to be scanned by the user. The apparatus is controlled in response to the defined markings.

This application claims priority to Indian Patent Application No. 890/CHE/2008, entitled “SIMPLIFIED OPERATION OF SCAN AND PRINT DEVICES”, filed on Apr. 9, 2008, which is hereby incorporated by reference in its entirety.

### BACKGROUND OF THE INVENTION

This invention relates to simplified operation of scan based devices that support printing, and multi-function devices.

Multifunction scan-based devices are becoming increasingly popular, both for the home and the office. Such devices are known as “multi function printers” or “All in Ones”, and can typically print, scan and copy, and optionally also generate faxes and emails. These devices typically have a user input system based on a hierarchy of menus. These menus need to be provided on a relatively small screen. This sometimes makes the user experience complicated, as a user needs to navigate to find the right setting through the control panel.

With many different options relating to the different basic functions (of scanning, copying, printing, faxing and emailing), finding a particular menu option can become a complicated and time consuming task. Input of additional parameters required by these options such as email addresses and fax numbers through this interface can also be quite tedious.

The problem has been recognized, and one proposed solution is to have dedicated buttons for some of the most frequently used functionality settings on the control panel. In addition, efforts have been made to make menu structures as intuitive as possible to allow easier navigation. For example, the use of touch and stylus inputs also aims to improve the menu navigation experience.

### BRIEF DESCRIPTION OF THE DRAWINGS

Examples of the invention will now be described in detail with reference to the accompanying drawings, in which:

FIG. 1 shows a first, scanning and printing, step of the use of a system forming an example of the invention;

FIG. 2 shows a completed annotation version of the document generated by the step in FIG. 1;

FIG. 3 shows a second, scanning step of the use of a system forming an example of the invention;

FIG. 4 shows another example of possible use of a system forming an example of the invention;

FIG. 5 shows another example of possible use of a system forming an example of the invention;

FIG. 6 shows another example of possible use of a system forming an example of the invention; and

FIG. 7 shows another example of possible use of a system forming an example of the invention.

### DETAILED DESCRIPTION

Examples of the invention relate to a device with document scanning and printing capability and a processor for controlling the device functions. The device has the ability to analyse a scanned image of a special annotation version of the document that is printed by the device, to detect one or more defined markings on the annotation version. These are used to control the device and avoid complicated user inputs on a conventional interface for such a device.

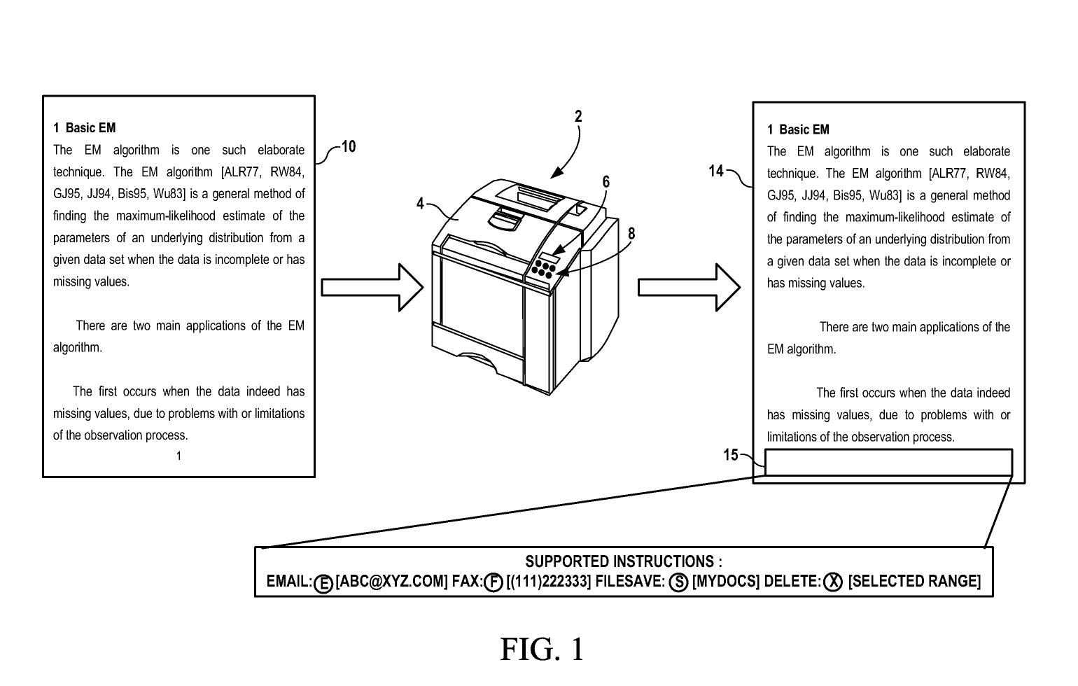

FIG. 1 shows a first example of how the device operates. The device 2 in this example is a multifunction device, and has a scan bed under the lid 4, a display screen 6 for displaying menu-based function options relating to the scanning operation, and an input device 8 for receiving function selections from a user. The input device can comprise buttons, as shown. However, also a touch sensitive display screen, for operation by finger touch or using a stylus, can be used.

The device has a processor which controls the display screen to display menu options, based on the previous function selections received from the user (using the button, touch or stylus input).

The device is used to generate an annotation version of a document to be processed. This annotation version is marked up by the user to provide instructions to the device for the desired processing of the document.

In a first step, the original document, shown as 10, is scanned by the device in response to a command input by the user to “generate an annotation version”. This can be a dedicated button on the input control panel 8.

The device then prints an annotation version, shown as 14.

In an example, this comprises a scaled (reduced) version of the document, so that a border is generated which is used for two purposes.

Firstly, a key 15 is provided in the border, which outlines the available functions which can be manually annotated. In the example shown in FIG. 1, the functions listed are email (E), fax (F), file save (S) and delete (X). The key indicates to the user the functions that are available, and also the format which the annotations need to follow for them to be recognised by the device.

A 90% scaled version can for example be provided to give adequate margins for the annotations and for the key.

The scanned original document is stored in memory, so that it can be processed once the annotated instructions are received.

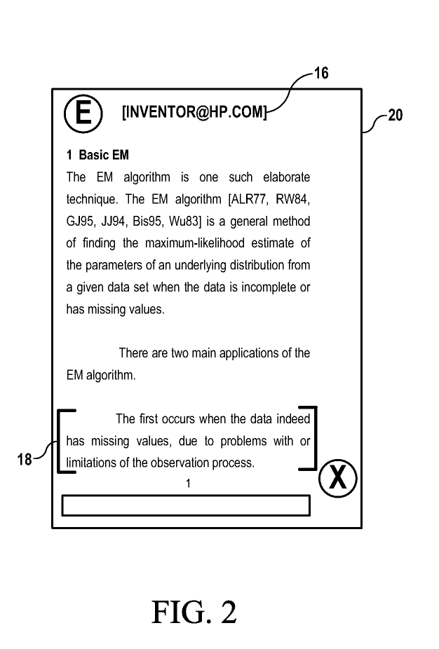

The user then provides instructions on the printed document in the format specified. The completed annotation version is shown in FIG. 2. In this example, the annotations indicate with instruction 16 that an email is to be sent (character ‘E’), with the email address provided in square brackets, and also indicate that a part of the document surrounded by square brackets 18 is to be deleted first (the character ‘X’ indicates that a deletion is required and the square brackets identify the portion). The circle and character are both hand drawn by the user, or annotations can be pre-printed and stuck on by the user.

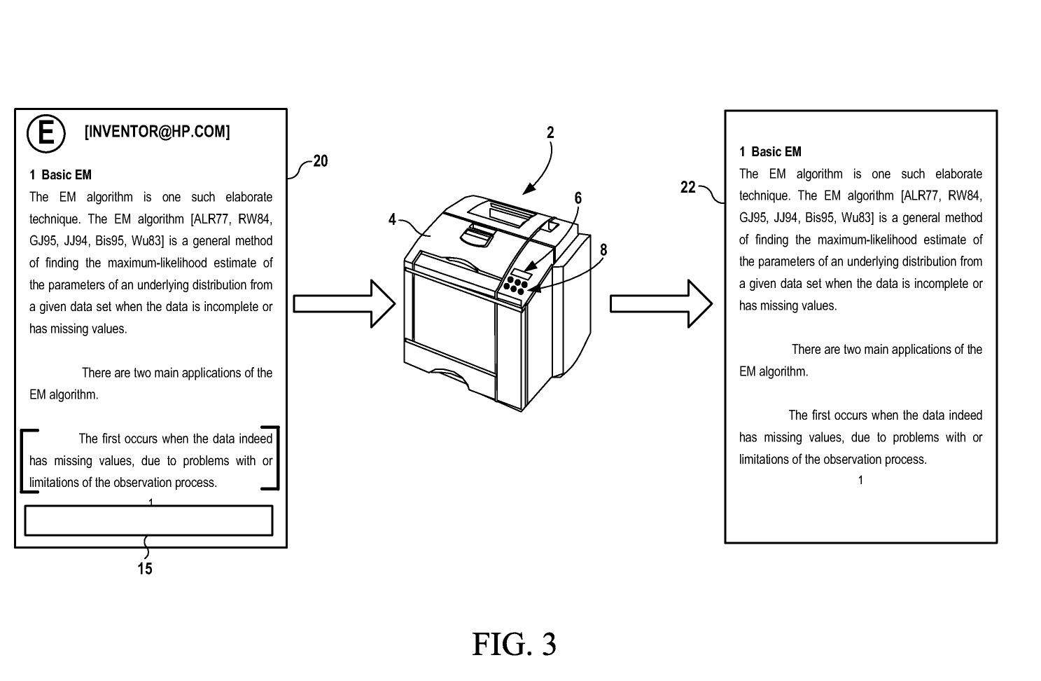

This completed annotation version 20 of the document is then scanned as shown in FIG. 3.

The processor of the device analyses the scanned document, and scales the position of any markings which are linked to the document content, such as the square deletion brackets shown, so that they can be applied to the previously saved version of the original document 10.

The email is then generated and sent (although a “confirm send email” action may be required as input to the input device 8). The emailed document is shown as 22, and does not include the deleted part, and also does not include the key 15 or annotations.

The user discards the annotation sheet, or keeps it for record purposes.

In this approach, the user is kept aware of the current set of supported instructions, and the information provided can be kept up to date. The annotation version means that the original document does not need to be marked, but the annotations can still identify portions of the original that have to be processed in a certain way. The annotation version ensures there is space for the markings, even if the original has very narrow margins.

By marking an annotation version, errors made do not matter—another annotation version can simply be printed.

Because the system has in memory the scanned original, this can be used to assist in the interpretation of the markings made on the annotation version. In particular, the original can be scaled (in the same way as the scaling applied to generate the annotation version) and subtracted from the annotation version. In this way, markings on the original which could incorrectly be interpreted as annotated instructions can be ignored. This also enables the system to look for annotations even if they are not strictly within the margins around the annotation version, but extend into the area of the original document image.

Ideally, the number of annotations should be kept relatively small, so that the use of annotations can remain intuitive. As explained further below, different sets of annotations can be provided for different types of operations, again so that the number of options is kept manageable. However, this means that the annotations in some cases may not be able to provide all the inputs needed for the device to complete a task, and some additional input may still be needed, for example using the keypad or touch screen.

The annotations can also be used to simplify this more conventional data input operation by using the annotations to provide menu shortcuts.

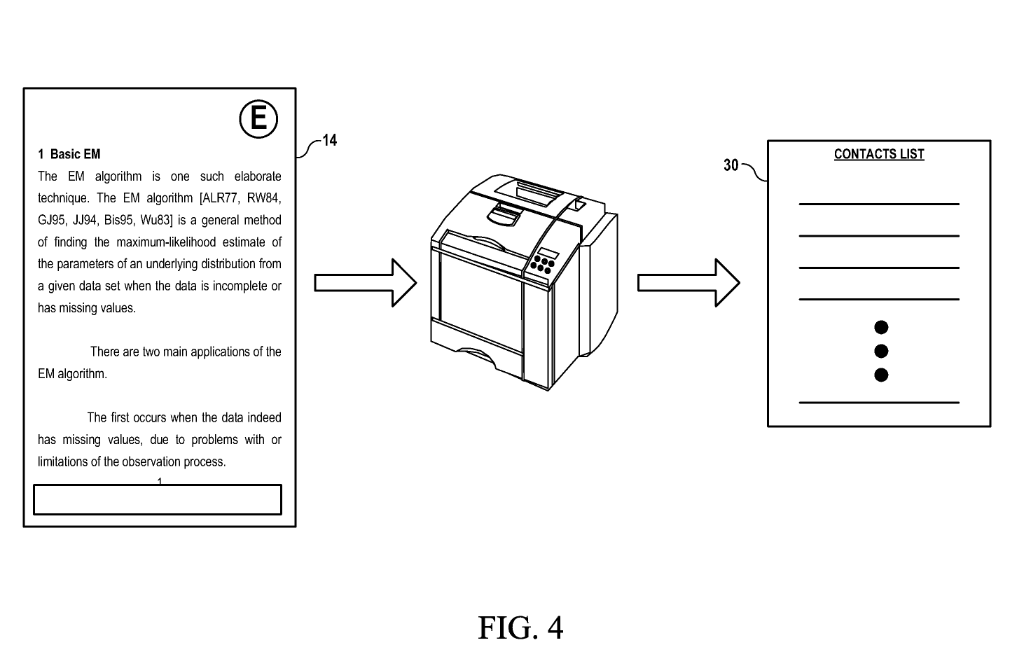

For example, as shown in FIG. 4, the annotation version 14 has been marked with a character ‘E’ drawn in the top right of the document. This indicates that the user would like a menu which relates to the sending of an email, but the complete information for sending the email has not been provided so that further input is required.

In response to this, the system is controlled to generate a menu list on the screen, shown as 30 which in this example is a contacts list for the user to select the email address to which the email is to be sent.

The annotations which can be recognised could either be pre-defined by the system, defined by the system but changed by the user (for instance the user may prefer to use the character @ for this shortcut), or the markings can be defined by the user to be personalized by a suitable interface (an electronic interactive interface or paper based interface which is scanned in) to configure the markings initially.

In this example, the device controls the menu options based on an analysis of the symbols within the scanned document, so that shortcuts are provided to menu options that the user needs (or wishes) to access in order to complete any of the operations the device provides.

In the examples of FIGS. 1 to 4, the user-input annotations are in a predefined notation of being circled to provide demarcation. Of course other ways of identifying that a marking is for interpretation by the scanner can be used—for example specific colours, shapes, or unusual symbols which will not appear in typical documents.

The symbols may be linked to the type of scan, for example a scan, copy, email or fax. This basic type of operation may have to be selected by the user when operating the device, and can therefore be considered as the highest level of instruction. This means that the same symbol can have different meanings for different basic types of scan. The advantage of this is that the symbols can be made as intuitive as possible.

Thus, when instructing the generation of the annotation version, the user can select a fax annotation version, an email annotation version, a scan annotation version or a copy annotation version. In each case, the instructions shown in the key will then be different.

In this example, there is thus one layer of high level instruction which needs to be selected before the annotation version is generated, and the symbols can be interpreted. Instead, there may be two or more layers of instruction which are received before the annotation version is printed. This enables the symbols to be used within that type of operation to be more intuitive.

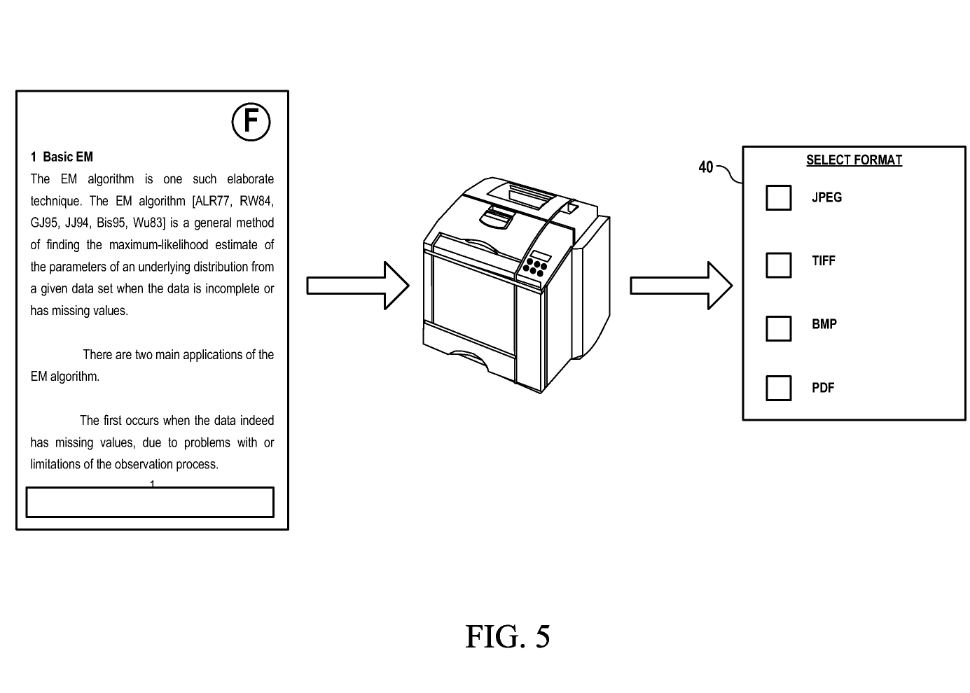

FIG. 5 shows a symbol ‘F’ used to indicate that a file format menu should be given. This relates to email functionality, and the user may want to email the document in a format which is not the default. The corresponding menu 40 is shown which is displayed on the screen to enable the user to select the file format. Alternatively, the file format can be one of the annotations that can be made as part of the email command 16 (shown in FIG. 2), so that no menu selection at the input 8 is required.

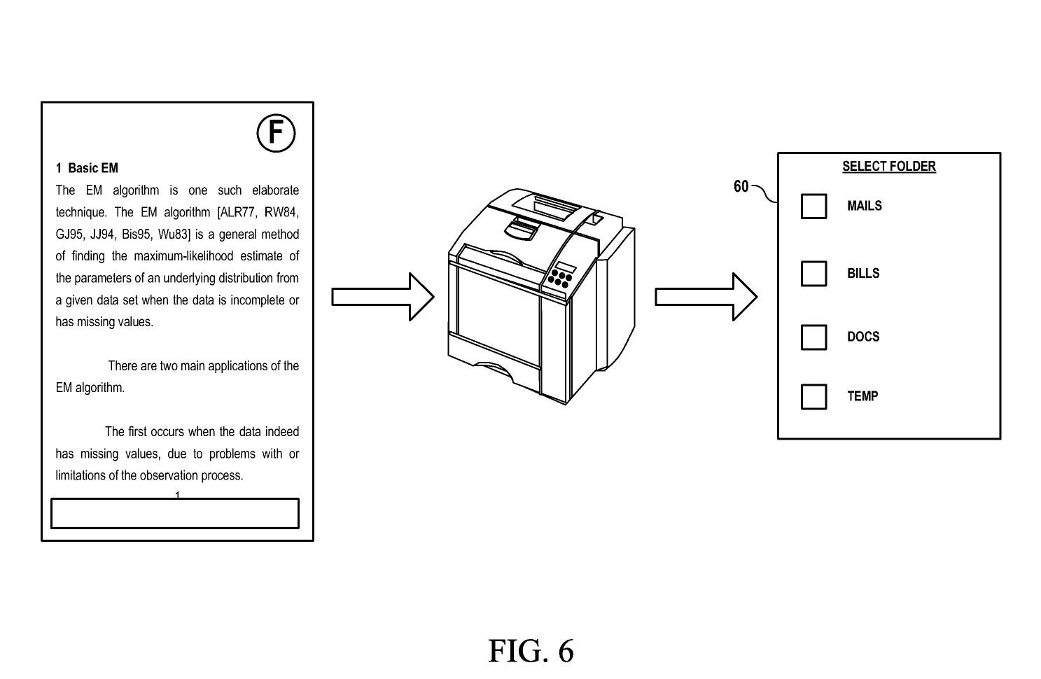

FIG. 6 shows a symbol ‘F’ used to indicate that a file save folder menu should be given. This relates to a scan functionality (rather than the email functionality of FIG. 5), and enables the user to select the folder in which the scanned document is to be saved. The corresponding menu 60 is shown which is displayed on the screen to enable the user to select the file save folder. Thus, the symbol ‘F’ can be used both to select the folder and the format for different functionality and is therefore context-sensitive.

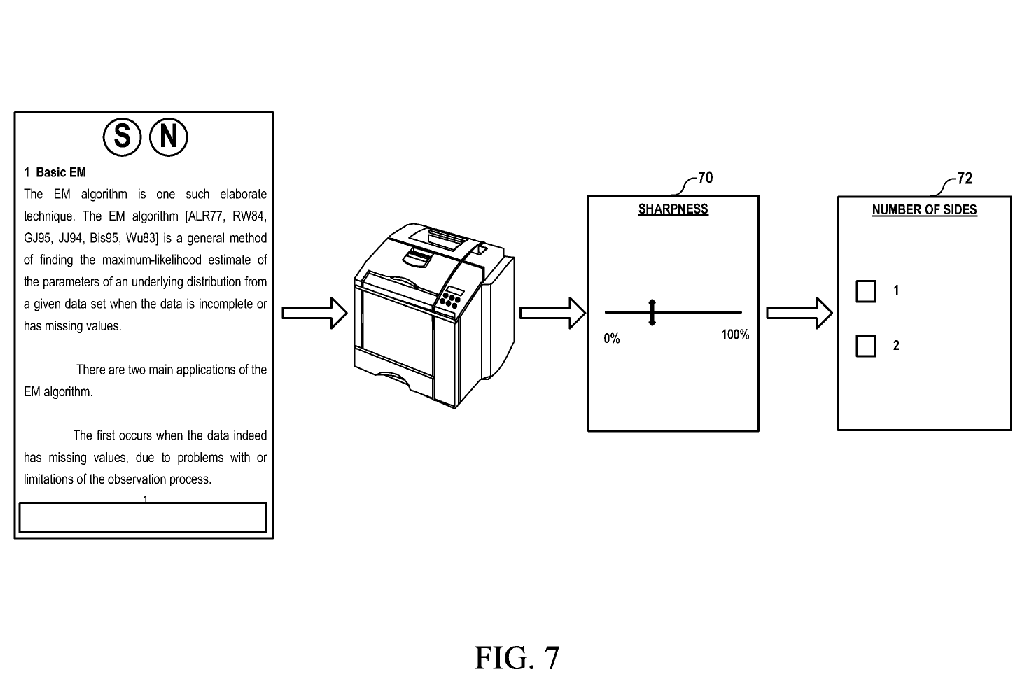

FIG. 7 shows two symbols ‘S’ and ‘N’ for use with copy functionality. This can be used to allow the user to select the sharpness of a page at the time of copying a document, using the letter ‘S’, and the number of sides to be printed using the letter ‘N’.

When the completed annotation version has been scanned, the device provides the control panel menu structure corresponding to sharpness, as shown at 70. Again, the user does not need to navigate to find it. FIG. 7 shows that multiple shortcuts can be provided. The system recognizes and stores each annotation and in sequence provides the menus that the user has provided shortcuts for. In FIG. 7, a second menu option 72 gives the user the option of selecting whether the copying is to be single-sided or double-sided.

Again, if the annotations recognised can include these functions, then there is no need to require user input, and the device can complete the task simply based on the written annotations.

The device above enhances the user experience for scan based devices. By providing an up to date key with each annotation version (and the key can optionally be tailored to the basic function being carried out), the user input is simplified. The use of menu shortcuts when the annotations do not provide all the control settings desired to be set enables the number of different symbols be kept small so the use of the symbols does not add excessive complexity to the operation of the device.

The image processing required to recognise and analyse the markings is well known. The use of a continuous line around a marking enables easy demarcation but other syntax can also be used for demarcation.

Handwritten character recognition software is also widely known for analyzing text portions. Thus, the implementation of the processing algorithm required will be completely routine to those skilled in the art. The control implemented once a marking has been recognised is simply comparable with an input to the graphical user interface. The implementation of the device control (or menu control) is thus also routine to those skilled in the art.

The system can be implemented as part of the software controlling the GUI of the device.

The examples of annotation options given above are only a few examples. In practice, the full range of functions provided by the device can be analysed to select those which are most appropriate for annotation control.

Equally, the use of a circle to identify commands is only one example of a possible method. Colour may instead be used, or particular symbols to indicate the start and/or end of a command.

As mentioned above, the command symbols can be set or changed by the user, to make the device operation as intuitive as possible for a particular user. Furthermore, the device functions for which shortcuts are provided can also be set or amended by the user.

In the examples above, the device generates an annotation version. However, it may also have a mode of operation which provides recognition of annotations directly on the document first scanned. For example, the commands shown in FIGS. 4 to 7 which generate menu shortcuts, can be provided directly on the scanned original. This approach is the subject of a co-pending application of the assignee. The device then needs to process the scanned image to remove the recognised markings before processing the image. For this mode, the whole document may be analyzed so that the user can write the symbol anywhere there is a blank space of sufficient size, or else other specific areas can be used, for example anywhere in the outer border.

The scan system used in the device can be entirely conventional, for example it can comprise reduction optics charge-coupled-devices (CCD) and/or contact-image-sensors (CIS). The scanned document can be stored in a compressed form, using lossy and/or lossless compression algorithms.

The display screen 6 can provide an output based on a graphical display or a text-based display, or a combination of these to provide the most intuitive user input.

The system can be applied to both color and monochrome scan and print systems.

The processor/processor means is not shown specifically in the drawings, but this is implemented by the existing processor of the apparatus 2.

While specific embodiments have been described herein for purposes of illustration, various modifications will be apparent to a person skilled in the art and may be made without departing from the scope of the invention.

We claim:

1. An apparatus comprising a document scanner and a document printer, comprising:
a scan system; and
a processor means which is adapted to:
control the scanner to scan a document;
generate an annotation version of the document;
control the printer to print the annotation version of the document;
control the scanner to scan a completed annotation version of the document;
analyse the scanned completed annotation version to detect one or more defined markings on the scanned document in addition to the document content desired to be scanned by the user; and
in response to detection of one or more defined markings, to control the apparatus in response to the defined markings.

2. An apparatus as claimed in claim 1, wherein the defined markings which can be detected comprise shortcuts to respective user functions of the apparatus.

3. An apparatus as claimed in claim 1, wherein the user functions can be selected and/or amended by the user.

4. An apparatus as claimed in claim 1, wherein the defined markings which can be detected comprise shortcut commands giving:
an indication that generation of an email is desired; and/or
an indication that generation of a fax is desired; and/or
an indication that saving of the scanned document to a specified location is desired; and/or
an indication that deletion of part of the document is desired.

5. An apparatus as claimed in claim 1, wherein the processor is adapted to allocate the defined marking to an associated set of commands dependent on a category of apparatus function, such as a scan, copy, email or fax.

6. An apparatus as claimed in claim 1, wherein the defined markings comprise a set of symbols.

7. An apparatus as claimed in claim 1, wherein the defined markings comprise a set of symbols coded with a machine readable identifier, for example a continuous border around a symbol.

8. An apparatus as claimed in claim 1, wherein the defined markings are detected in a pre-defined region of the scanned document.

9. An apparatus as claimed in claim 1, further comprising a memory for storing a scanned document until a completed annotation version of the document has been scanned, and wherein the processor interprets the annotations on the completed annotation version with reference to the stored scanned document.

10. An apparatus as claimed in claim 1, wherein the annotation version comprises a scaled version of the scanned document and explanations of the possible annotations.

11. A document scanning method, comprising:
scanning a document provided to the scan system of an apparatus which comprises a document scanner and a document printer;
generating and printing an annotation version of the document;
scanning a completed annotation version of the document;
analysing the scanned completed annotation version to detect one or more defined markings on the scanned document in addition to the document content desired to be scanned by the user; and
in response to detection of one or more defined markings, controlling the apparatus in response to the defined markings.

12. A document scanning method as claimed in claim 11, wherein the defined markings which can be detected comprise shortcuts to respective user functions of the apparatus.

13. A document scanning method as claimed in claim 11, wherein the user functions are selected and/or amended by the user.

14. A method as claimed in claim 11, wherein the defined markings which can be detected comprise shortcut commands giving:
an indication that sharpness control is desired; and/or
an indication that generation of an email is desired; and/or
an indication that a selection of file save format is desired; and/or
an indication that resolution control is desired; and/or
an indication that selection of file save location is desired; and/or
an indication that control of the number of sides in the generated scanned document is desired.

15. A method as claimed in claim 11, further comprising allocating the defined marking to an associated set of commands dependent on a category of apparatus function, such as a scan, copy, email or fax.

16. A method as claimed in claim 10, wherein the defined markings comprise a set of symbols.

17. A method as claimed in claim 11, wherein the defined markings comprise a set of symbols coded with a machine readable identifier, such as a continuous border around a symbol.

18. A method as claimed in claim 11, wherein the defined markings are detected in a pre-defined region of the scanned document.

19. A method as claimed in claim 11, further comprising storing a scanned document until the completed annotation version of the document has been scanned, and wherein the annotations on the completed annotation version are interpreted with reference to the stored scanned document.

20. A method as claimed in claim 11, wherein the annotation version comprises a scaled version of the scanned document and explanations of the possible annotations.

21. A computer program comprising computer program code adapted to perform all of the steps of claim 11 when the said computer program is run on a computer.

22. A computer program as claimed in claim 21 embodied on a computer readable medium.
